(19) United States
(12) Patent Application Publication
(10) Pub. No.: US 2008/0064412 A1
(43) Pub. Date: Mar. 13, 2008

(54) Mobile electronic apparatus capable of assisting car radio in tuning radio channel

(75) Inventor: Hung-Chi Huang, Taichung (TW)

Correspondence Address: REED SMITH LLP;Suite 1400, 3110 Fairview Park Drive, Falls Church, VA, 22042, US

(73) Assignee: Compal Communications, Inc.

(21) Appl. No.: 11/898,447

(22) Filed: Sep. 12, 2007

(30) Foreign Application Priority Data
Sep. 13, 2006 (TW) 095133791

(51) Int. Cl. H04Q 7/20

(52) U.S. Cl. 455/456.1

(57) ABSTRACT

The invention provides a mobile electronic apparatus capable of assisting a car radio in tuning a radio channel. The mobile electronic apparatus of the invention accesses current location information by a GPS module thereof, then according to the current location information and a look-up table, determines a channel, and finally, transmits a signal representative of the determined channel to the car radio. The car radio converts the signal into the determined channel information and tunes the radio channel to the determined channel. Therefore, a user just needs to input a requested radio station, so as to make the car radio tune the radio channel by the mobile electronic apparatus automatically.

### BACKGROUND OF THE INVENTION

1. Field of the Invention

The present invention relates to a mobile electronic apparatus capable of assisting a car radio in tuning to a desired channel, and more particularly, relates to a mobile electronic apparatus capable of automatically tuning to the desired channel.

2. Description of the Prior Art

Presently, a radio station usually broadcasts on different channels in different regions. When a user listens to the radio station in a car, and the car is driven from an original broadcasting region to another broadcasting region, the user has to tune the radio channel so as to listen to the radio station continually. For example, ICRT radio station, a famous radio station in Taiwan, broadcasts on FM100.7 in Taipei, on FM100.1 in Miaoli, and on FM100.7 in Kaohsiung. Then the user has to switch the radio channel based on the corresponding relation, so as to listen to the radio station continually. However, the user cannot usually memorize the relation between stations, broadcasting regions, and channels. Moreover, if the user is the driver of the car, tuning by hand is not only inconvenient but also dangerous to the user. Therefore, if there is an automatic switch mechanism, the danger to drive can be reduced, and the listen quality improves.

Accordingly, a scope of the invention is to provide a mobile electronic apparatus capable of assisting a car radio in tuning a radio channel, so as to reduce the danger to drive and to improve the listen quality.

### SUMMARY OF THE INVENTION

A scope of the invention is to provide a mobile electronic apparatus capable of assisting a car radio in tuning a radio channel.

According to a preferred embodiment, a mobile electronic apparatus of the invention is capable of assisting a car radio in tuning a radio channel. The car radio includes a signal receiver. The mobile electronic apparatus includes a storage module, a GPS module, a signal transmitter, a user input interface, a processing module, and a communication module. The processing module is electrically connected to the storage module, the GPS module, the signal transmitter, the user input interface, and the communication module.

The storage module stores a look-up table, which records a plurality of channels, a plurality of radio stations, and a plurality of geographic regions. Each of the radio stations corresponds to one or more of the geographic regions and related channels. The user input interface is used for a user to input a requested radio station. The communication module is capable of linking to a data center through a radio telecommunication network to download an updated look-up table from the data center to replace the look-up table stored in the storage module.

The processing module triggers the GPS module to access current location information in response to the requested radio station. Then the processing module determines one from the channels stored in the storage module in accordance with the requested radio station, the current location information, and the look-up table. Next, the processing module controls the signal transmitter to transmit a signal representative of the determined channel to the signal receiver of the car radio. At last, the car radio converts the signal received by the signal receiver into determined channel information and tunes the radio channel to the determined channel. Furthermore, the processing module can also trigger the GPS module again to access the current location information based on a predetermined period. Then the processing module determines one of the channels in accordance with the requested radio station, the current location information, and the look-up table. Next, the processing module transmits a signal to the car radio. At last, the car radio tunes the radio channel to the determined channel. Therefore, the mobile electronic apparatus can automatically assist the car radio in tuning the radio channel.

Obviously, the mobile electronic apparatus of the invention can assist a car radio in tuning a radio channel, so as to reduce the danger to drive and to improve the listen quality. Furthermore, the mobile electronic apparatus is capable of automatically assisting the car radio in tuning the radio channel.

The advantage and spirit of the invention may be further understood by the following recitations together with the appended drawings.

### BRIEF DESCRIPTION OF THE APPENDED DRAWINGS

FIG. 1 is a function block diagram of a preferred embodiment according to the invention.

FIG. 2 is a sketch diagram illustrating a look-up table according to the preferred embodiment.

### DETAILED DESCRIPTION OF THE INVENTION

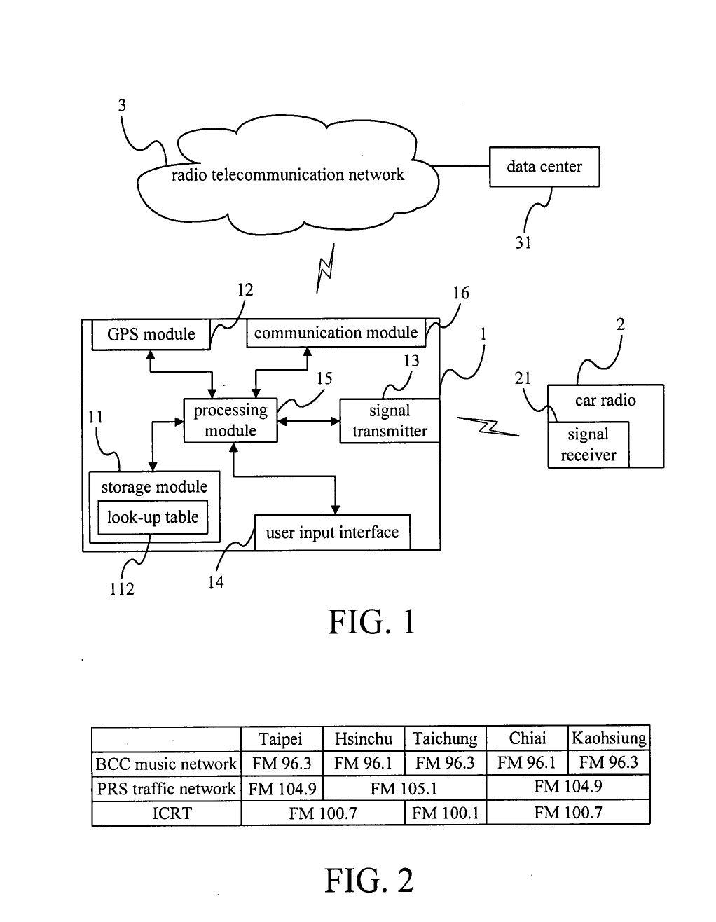

Please refer to FIG. 1. FIG. 1 is a function block diagram of a preferred embodiment according to the invention. A mobile electronic apparatus 1 of the invention is capable of assisting a car radio 2 in tuning a radio channel. The car radio 2 includes a signal receiver 21. The mobile electronic apparatus 1 includes a storage module 11, a GPS module 12, a signal transmitter 13, a user input interface 14, a processing module 15, and a communication module 16. The processing module 15 is electrically connected to the storage module 11, the GPS module 12, the signal transmitter 13, the user input interface 14, and the communication module 16 respectively. According to the preferred embodiment, the mobile electronic apparatus 1 is a cellular phone with GPS. However, a PDA with GPS can also be applied.

The storage module 11 stores a look-up table 112. Please refer FIG. 2. FIG. 2 is a sketch diagram illustrating the look-up table 112 according to the preferred embodiment. As shown in FIG. 2, the look-up table 112 records a plurality of channels, a plurality of radio stations, and a plurality of geographic regions. Each of the radio stations corresponds to one or more of the geographic regions and related channels. In actual applications, though a radio station may use the same channel in different geographic regions, the look-up table 112 can also be designed such that the mergence in FIG. 2 will not appear, and instead, the same corresponding relation in essence is represented by repeating the channel so as to simplify the mapping logic in performance. The user input interface 14 is for a user to input a requested radio station.

The processing module 15 triggers the GPS module 12 to access current location information in response to the requested radio station. Then the processing module 12 determines one from the channels stored in the storage module 11 in accordance with the requested radio station, the current location information, and the look-up table 112. According to the preferred embodiment, the requested radio station inputted via the user input interface 14 by the user is ICRT radio station, and the accessed current location information is Taichung. Consequently, the channel is FM100.1 in accordance with the look-up table 112.

Then the processing module 15 controls the signal transmitter 13 to transmit a signal representative of FM100.1 to the signal receiver 21 of the car radio 2. At last, the car radio 2 converts the signal received by the signal receiver 21 into FM100.1 and tunes the radio channel to FM100.1.

Furthermore, the processing module 15 can trigger the GPS module 12 to access the current location information in a predetermined period, such as every ten minutes. Next, the processing module 15 determines one from the channels in accordance with the requested radio station, the current location information, and the look-up table 112. Then, the processing module 15 transmits a signal to the car radio 2. At last, the car radio 2 tunes the radio channel to the determined channel. For example, maybe in ten minutes, the car radio 2 has been in the broadcasting region of Kaohsiung, so the processing module 15 will determine a new channel, FM100.7, in accordance to the current location information and the car radio 2 will tune the radio channel to FM100.7. Therefore, the mobile electronic apparatus 1 is capable of automatically assisting the car radio 2 in tuning the radio channel.

In addition, the communication module 16 is capable of linking to a data center 31 through a radio telecommunication network 3 to download an updated look-up table from the data center 31 to replace the look-up table 112 stored in the storage module 11, as shown in FIG. 1. Furthermore, the signal transmitter 13 of the mobile electronic apparatus 1 and the signal receiver 21 of the car radio 2 are configured to communicate with each other in an infrared way, a bluetooth protocol, or other radiation-based signal control ways. The communication module 16 is configured to communicate with the radio telecommunication network 3 in a wireless-fidelity protocol, a zigbee protocol, or other communication protocols.

Therefore, the mobile electronic apparatus of the invention can assist a car radio in tuning a radio channel, so as to reduce the danger to drive and to improve the listen quality. Furthermore, the mobile electronic apparatus is capable of automatically assisting the car radio in tuning the radio channel.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims

What is claimed is:

1. A mobile electronic apparatus capable of assisting a car radio in tuning a radio channel, the car radio comprising a signal receiver, said mobile electronic apparatus comprising:
a storage module therein storing a look-up table recording a plurality of channels, a plurality of radio stations, and a plurality of geographic regions, each of the radio stations corresponding to one or more of the geographic regions and related channels;
a GPS module;
a signal transmitter;
a user input interface for a user to input a requested radio station; and
a processing module electrically connected to the storage module, the GPS module, the signal transmitter, and the user input interface respectively, for triggering the GPS module to access current location information in response to the requested radio station, determining one from the channels stored in the storage module in accordance with the requested radio station, the current location information, and the look-up table, and controlling the signal transmitter to transmit a signal representative of the determined channel to the signal receiver of the car radio, wherein the car radio converts the signal received by the signal receiver into determined channel information and tunes the radio channel to the determined channel.

2. The mobile electronic apparatus of claim 1, wherein the processing module also triggers the GPS module again to access the current location information in a predetermined period.

3. The mobile electronic apparatus of claim 1, wherein the signal transmitter is configured to transmit the signal in an infrared way, and the signal receiver is configured to receive the signal in the infrared way.

4. The mobile electronic apparatus of claim 1, wherein the signal transmitter is configured to transmit the signal in a bluetooth protocol, and the signal receiver is configured to receive the signal in the bluetooth protocol.

5. The mobile electronic apparatus of claim 1, further comprising a communication module capable of linking to a data center through a radio telecommunication network to download an updated look-up table from the data center to replace the look-up table stored in the storage module.

6. The mobile electronic apparatus of claim 5, wherein the communication module is configured to communicate with the radio telecommunication network in a wireless-fidelity protocol or a zigbee protocol.
